(19) United States
(12) Patent Application Publication
(10) Pub. No.: US 2016/0218637 A1
(43) Pub. Date: Jul. 28, 2016

(54) A NEW FOUR-LEVEL CONVERTER CELL TOPOLOGY FOR CASCADED MODULAR MULTILEVEL CONVERTERS

(71) Applicant: SIEMENS AKTIENGESELLSCHAFT ., Munich (DE)

(72) Inventors: Shengfang Fan, Plainsboro, NJ (US); Yaosuo Xue, Monroe, NJ (US)

(21) Appl. No.: 14/915,269

(22) PCT Filed: Sep. 23, 2013
(86) PCT No.: PCT/US2013/061127

§ 371 Date: Feb. 29, 2016

(51) Int. Cl. H02M 7/44; H02M 1/12

(52) U.S. Cl. CPC H02M 7/44; H02M 1/12

(57) ABSTRACT

A cascaded modular multilevel converter has a plurality of 4-level converters, each ac phase generates the multilevel voltage waveforms composed of different outputs of the modules in the same phase. Each module is a controlled voltage source. The number of voltage levels in the cascaded converter is determined by the number of modules in each phase and the voltage levels generated by each module. N cascaded 4-level converters generate 4N+1 phase-to-neutral voltage levels and 8N+1 phase-to-phase voltage levels.

### TECHNICAL FIELD

The present invention is related to systems and methods for voltage conversion.

More in particular it relates to methods and systems to convert DC voltage to AC voltage in power systems with cascaded individual multilevel power inverters.

### BACKGROUND

Multilevel converters have become popular due to the demands of high power and high voltage applications such as HVDC, SVC and AC drives. Different from conventional two-level converters, a multilevel inverter provides an efficient way to cancel harmonics based on the synthesis of ac voltage waveform from several dc voltage levels, which have many advantages as described in ‘[1] O. Lopez, S. Bernet, J. Alvarez, J., D., Gandoy and F. D. Freijedo, “Multilevel multiphase space vector PWM algorithm,” IEEE Trans. Ind., Electron., vol. 55, no. 5, pp. 1933-1942, May 2008’; ‘[2] J. Rodriguez, J. Lai, and F. Z. Peng, “Multilevel inverters: a survey of topologies, controls, and applications,” IEEE Trans. Ind., Electron., vol. 49, no. 4, pp. 724-738, Aug. 2002’; ‘[3] S. Bernet, D. Krug, and K. Jalili, “Design and comparison of 4-kV neutral-point-clamped, flying-capacitor, and series-connected H-bridge multilevel converters,” IEEE Trans. Ind., Appl., vol. 43, no. 4, pp. 1032-1040, Jul./Aug. 2007’ and [4] S. Kouro, M. Malinowski, K. Gopakumar, J. Pou, L. G. Franquelo, B. Wu, J. Rodriguez, M. A. Peroez and J. I. Leon, “Recent advances and industrial applications of multilevel converters,” IEEE Trans. Ind., Electron., vol. 57, no. 8, pp. 2553-2580, Aug. 2010.

The advantages of multilevel converters are:
a) High voltage capability with voltage limited devices;
b) Low harmonic distortion and less filtering requirements;
c) Reduced switching losses due to low switching frequency;
d) Increased power conversion efficiency; and
e) Good electromagnetic compatibility.

Several multilevel converter topologies have been investigated and applied, for example, diode-clamped multilevel converter also called neutral point clamping (NPC) topology, flying-capacitor multilevel converter, cascaded H-bridge multilevel converter (CHB), modular multilevel converter (MMC or M2C) as described in ‘[5] A. Lesnicar and R. Marquardt, “An innovative modular multilevel converter topology suitable for a wide power range,” in Proc. IEEE Bologna Power Tech Conf., 2003, pp. 1-3. It is known that certain problem exists in NPC converters, such as voltage imbalance when the number of voltage levels is more than three as described in ‘[2] J. Rodriguez, J. Lai, and F. Z. Peng, “Multilevel inverters: a survey of topologies, controls, and applications,” IEEE Trans. Ind., Electron., vol. 49, no. 4, pp. 724-738, Aug. 2002’. A similar problem is also found in flying-capacitor multilevel converters. To solve these problems, the modular multilevel converters have been investigated by many researchers in recent years. Cascaded H-bridge multilevel converters are one of those commonly used when voltage is higher than 6 kV.

The M2C topology uses half-bridge sub modules and has been commercialized by Siemens Corporation, the assignee of the instant disclosure. Advantages with modular multilevel converters include, 1) ease of expandability with modular design, 2) distributed location of capacitors which are smaller and reliable, and 3) simple realization of redundancy.

Currently, the number of voltage levels in a multilevel converter with at most 4 switches is believed to be limited which also limits the number of voltage levels in a circuit of cascaded converters.

Accordingly novel and improved multi-level (also called multilevel) converters with a greater number of voltage levels and that can be applied in a cascaded topology are required.

### SUMMARY

In accordance with an aspect of the present invention a converter cell to generate a multilevel voltage is provided, comprising a first, a second and a third capacitor connected in series; a first, a second, a third and a fourth power switch, each power switch having a diode connected in anti-parallel, wherein the first power switch is connected in series with the second power switch and the third power switch is connected in series with the fourth power switch; the first and second power switches connected in series are connected in parallel with the second capacitor; and a first node of the third power switch is connected to a first node of the first capacitor; and a second node of the fourth power switch is connected to a second node of the third capacitor.

In accordance with a further aspect of the present invention, a converter cell is provided, further comprising an output formed by a second node of the first power switch and a second node of the third power switch to provide the multilevel voltage.

In accordance with yet a further aspect of the present invention a converter cell is provided, wherein the multilevel voltage is a four level voltage.

In accordance with yet a further aspect of the present invention a converter cell is provided, wherein the converter cell is part of a circuit containing a plurality of converter cells.

In accordance with yet a further aspect of the present invention a converter cell is provided, wherein the circuit contains n converter cells with n being greater than 2 and the circuit is configured to provide an phase-to-neutral output voltage with at least 4n+1 voltage levels.

In accordance with yet a further aspect of the present invention a converter cell is provided, wherein the circuit contains 3n converter cells with n being greater than 2 and the circuit is configured to provide an phase-to-phase output voltage with at least 8n+1 voltage levels.

In accordance with yet a further aspect of the present invention a converter cell is provided, wherein the converter cell is part of a cascaded modular multilevel converter.

In accordance with yet a further aspect of the present invention a converter cell is provided, wherein the converter cell is part of a solar cell power system.

In accordance with yet a further aspect of the present invention a converter cell is provided, wherein a capacitor in the converter cell is replaced by a solar cell.

In accordance with another aspect of the present invention a multilevel voltage converter is provided, comprising: a plurality of 3n converter cells arranged in a cascaded modular multilevel converter topology, each converter cell having a topology determined by 3 capacitors and 4 power semiconductor switches each with a free-wheeling diode, each converter having an output configured to selectively provide one of 4 voltage levels; and an output enabled to selectively provide one of at least 8n+1 phase-to-phase voltage levels.

In accordance with yet another aspect of the present invention a multilevel voltage converter is provided, wherein the topology is further determined by connecting the three capacitors in series and by connecting two of the four power switches in series.

In accordance with yet another aspect of the present invention a multilevel voltage converter is provided, wherein the two power switches connected in series are connected in parallel to one of the three capacitors connected in series.

In accordance with yet another aspect of the present invention a multilevel voltage converter is provided, wherein the multilevel voltage converter is part of a solar cell power system.

In accordance with yet a further aspect of the present invention a method for generating a multilevel voltage signal is provided, comprising: outputting a voltage signal enabled to assume one of 4 levels on an output of a converter cell with a topology determined by 3 capacitors and 4 power semiconductor switches each with a free-wheeling diode; arranging n converter cells in a cascaded modular multilevel converter topology in a circuit; and selectively providing on an output of the circuit a signal enabled to assume one of at least 4n+1 phase voltage levels.

In accordance with yet another aspect of the present invention a multilevel voltage converter is provided, further comprising: arranging 3n converter cells in a cascaded modular multilevel converter topology in a circuit; and selectively providing on an output of the circuit a signal enabled to assume one of at least 8n+1 line voltage levels.

In accordance with yet another aspect of the present invention a multilevel voltage converter is provided, wherein the multilevel voltage is generated in a solar cell power system.

In accordance with yet another aspect of the present invention a multilevel voltage converter is provided, wherein the topology is further determined by connecting the three capacitors in series and by connecting two of the four power switches in series.

In accordance with yet another aspect of the present invention a multilevel voltage converter is provided, wherein the two power switches connected in series are connected in parallel to one of the three capacitors connected in series.

### DRAWINGS

FIG. 1 illustrates in diagram a cascaded modular multilevel converter (CMMC) topology;

FIG. 2 illustrates in diagram a full-bridge converter module which is applied in a cascaded H-bridge (CHB) topology;

FIGS. 3 and 4 illustrate a topology of a converter cell for CMMC topology in accordance with one or more aspects of the present invention;

FIG. 5 illustrates steps of a method provided in accordance with one or more aspects of the present invention; and

FIG. 6 illustrates an ac voltage generator in accordance with one or more aspects of the present invention.

### DESCRIPTION

In accordance with an aspect of the present invention a new four-level converter cell composed of four power semiconductor switches and three capacitors, is provided and is applied in cascaded modular multilevel converters (CMMC) which are used for high power and high voltage power transmission (e.g. SVC, STATCOM, etc.), high power medium-voltage drives, and utility-scale renewable energy and storage applications. The benefits of the converter cell provided in accordance with an aspect of the present invention are reduced cost, improved output ac harmonic spectral and reduced filtering requirements.

In one embodiment of the present invention the novel converter cell is part of a solar cell power system. In one embodiment of the present invention a capacitor required in a topology of the novel converter cell described below is replaced by one or more solar cells.

One aspect of the present invention is the creation of a multilevel ac waveform from either centralized dc link or floating or separate dc inputs, which is generally referred to as a multilevel converter or a multilevel inverter.

The term topology or network topology or circuit is applied herein. The topology of an electric or electronic circuit or network is the form taken by the network of interconnections of the circuit components. Different specific values or ratings of the components are regarded as being the same topology. Topology is not concerned with the physical layout or exact realization of components in a circuit, nor with their positions on a circuit diagram. A component in a topology represents the functional aspect of the component. The topology is concerned with what connections exist between the components. There may be numerous physical layouts and circuit diagrams that all amount to the same topology.

A topology herein means a topology related to a minimum number of functional components required to realize the circuit. It is well known that for instance a resistance can be realized with several resistors. It is also known that a single switch can be realized with a plurality of switches connected in series. Is also known that components such as electric connections, resistors, capacitors, switches and the like have parasitic values in their physical form. The topology of a circuit ignores these aspects and provides a structure in its minimal form, that is: with a minimum number of components that allows a circuit to be physically realized while performing the functional requirements of the topology.

Several multilevel converter topologies are provided in US Patent Application Publication Ser. No. 20130014384 to Xue et al. published on Jan. 17, 2013.

The switches in multilevel converters are gated switches that require a gating signal. Such a gating signal may be derived from a generated ac signal or from an external source during start-up (also known as black-start.) Generation of gating signals is described in PCT Patent Application Publication Ser. No. WO2012140008 A2 to Das et al, published on Oct. 18, 2012.

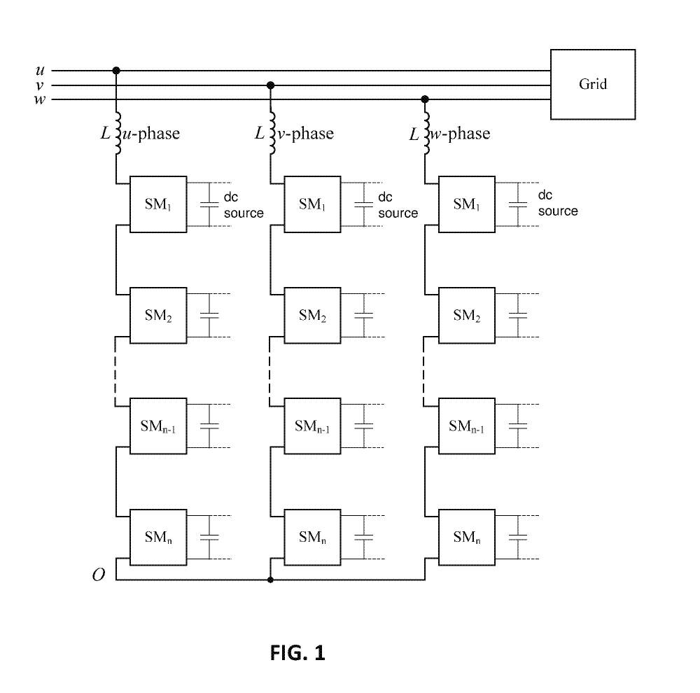

As an aspect of the present invention, the known CHB topology is extended to a CMMC topology, as shown in FIG. 1, which contains multiple cascaded modules or converter cells, each converter cell being indicated by SMₙ, wherein n indicates a row in the cascade and each cell in a row contributes to an output phase of the generated ac signal. Each cell is powered by a direct current (dc) source. Only the first row cells SM₁ are illustrated with a dc source, as not to obscure the topology of the cascade. However, each cell should be assumed to have a dc source. Furthermore, gating signals are not illustrated in any of the drawings, but are fully contemplated and should be assumed to be provided.

As an aspect of the present invention, a novel converter cell for CMMC topology is provided, which offers the benefit of the capability of generating higher alternating current (ac) levels using fewer power switches, thereby improving output ac harmonic spectrum and reducing filtering requirements.

One of the issues that is addressed by one or more aspects of the present invention is to increase the module's capability of generating higher ac voltage levels with a minimum number of power switches.

In a cascaded modular multilevel converter, each ac phase generates the multilevel voltage waveforms composed of different outputs of the modules in the same phase. Each module can be considered as containing controlled voltage sources. By switching a number of the N modules in each phase, the ac voltage (vᵤₒ, vᵥₒ, v_{wo}) can be adjusted. (The ac voltages refer to the different phases as illustrated in FIG. 1.)

The number of voltage levels is determined by the number of modules in each phase and the voltage levels generated by each module. Therefore, if the number of modules in each arm is fixed, it is preferred to apply modules with more voltage levels in order to achieve a higher number of voltage levels in each arm.

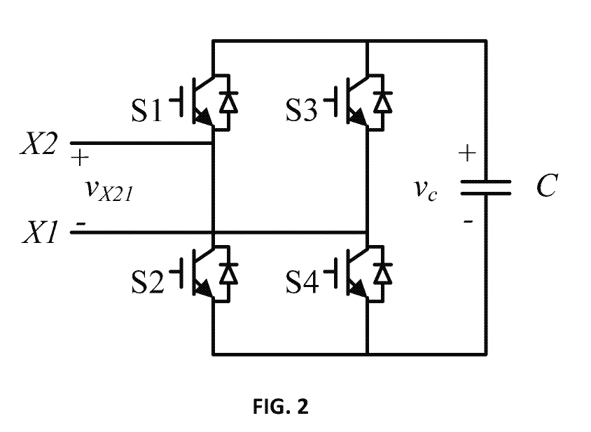

In a CHB topology, single-phase full-bridge (also called H-bridge) modules are used. FIG. 2 shows in diagram a full-bridge module which is applied in a cascaded H-bridge (CHB) topology. It shows a converter with 4 switches: S1, S2, S3 and S4, powered from a capacitor and providing an output voltage V_{X21}.

The following table illustrates the switching states of the full-bridge module of FIG. 2 (1=ON, 0=OFF)

| State No. | S1 | S2 | S3 | S4 | V_{X21} |
|---|---|---|---|---|---|
| 1 | 0 | 1 | 0 | 1 | 0 |
| 2 | 0 | 1 | 1 | 0 | −v_{c} |
| 3 | 1 | 0 | 0 | 1 | v_{c} |
| 4 | 1 | 0 | 1 | 0 | 0 |

As shown in the above table, the full-bridge module can generate 3 voltage levels with a topology of 4 power switches and one capacitor.

In accordance with an aspect of the invention, a novel cell topology is provided, which can generate 4 voltage levels with 4 power switches and 3 capacitors, which increases the output ac voltage levels.

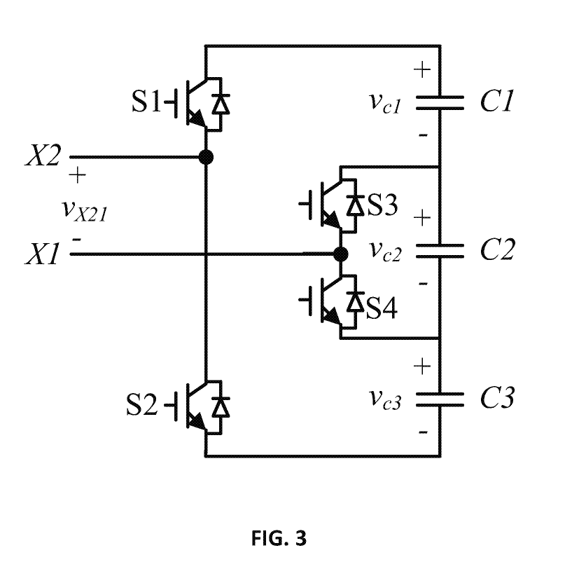

The novel converter cell is illustrated in FIG. 3. This converter cell topology contains four power semiconductor switches (which can be for instance MOSFETs, Insulated Gate Bipolar Transistors (IGBTs), Integrated Gate-Commutated Thyristor (IGCTs), etc. and the like with free-wheeling diodes) S1, S2, S3 and S4 and three capacitors C1, C2 and C3 which can be film capacitors.

At normal operation, the voltages of the three capacitors can be controlled to be balanced, that is, v_{c1}=v_{c2}=v_{c3}=v_{c}. In one embodiment of the present invention the capacitor voltages are the same or about the same and are controlled to be the same or about the same within a range of at least 10%. Since the capacitor may not be short-circuited, over the sixteen possible switching combinations, only four effective applicable switching states exist for the novel topology module, which can generate four different voltage levels, as shown in the following table.

| State | S1 | S2 | S3 | S4 | v_{X21} |
|---|---|---|---|---|---|
| 1 | 0 | 1 | 0 | 1 | −v_{c3} = −v_{c} |
| 2 | 0 | 1 | 1 | 0 | −(v_{c2} + v_{c3}) = −2v_{c} |
| 3 | 1 | 0 | 0 | 1 | v_{c1} + v_{c2} = 2v_{c} |
| 4 | 1 | 0 | 1 | 0 | v_{c1} = v_{c} |

The following table lists a comparison of output ac voltage maximum achievable levels when different cells (the full-bridge topology module and the new topology module) are used in a CMMC topology.

| Module | Phase Voltage Levels | | Phase-Phase Voltage Levels | |
|---|---|---|---|---|
| Number | Full-bridge | | Full-bridge | |
| (per phase) | Module | New Module | Module | New Module |
| 2 | 5 | 9 | 9 | 17 |
| 4 | 9 | 17 | 17 | 33 |
| 6 | 13 | 25 | 25 | 49 |
| N | 2n + l | 4n + 1 | 4n + 1 | 8n + 1 |

From the above table, it is clear that the novel topology module provided in accordance with an aspect of the present invention can achieve higher voltage levels in case of the same number of modules (or power switches) per phase, which can significantly improve the output ac harmonic distortion, and reduce filtering requirements. Meanwhile, under the same number of modules, the actual switching frequency of each power switch can be reduced and the efficiency will be improved.

The CMMCs with the new topology module provided in accordance with an aspect of the present invention can be used in different high power high/middle voltage applications, for example, static Var compensator (SVC), medium-voltage motor drive, solar power inverter, and energy storage applications.

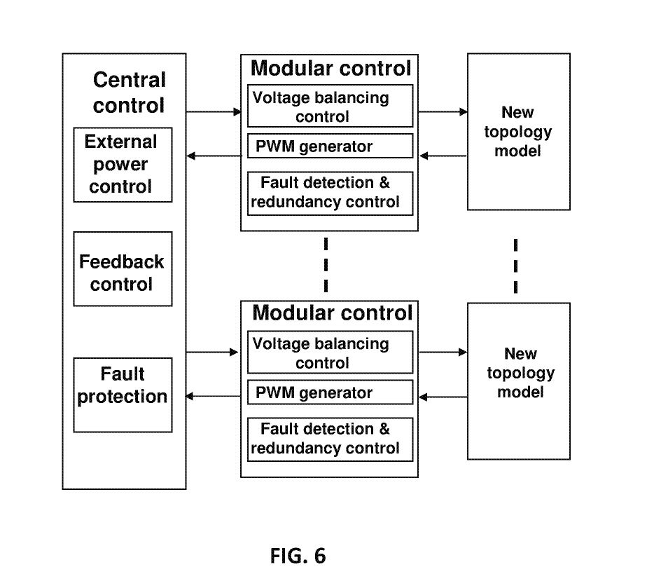

When applied for SVC applications, a simple control structure of CMMC is illustrated in FIG. 6, which contains both central control and modular control.

The novel topology converter module of FIG. 3 can be indicated by its components and its output as a 4 switch/3 capacitor/4 level converter. The topology of this inverter is determined by the structure or arrangements of the components.

The following provides a novel topology description in words.

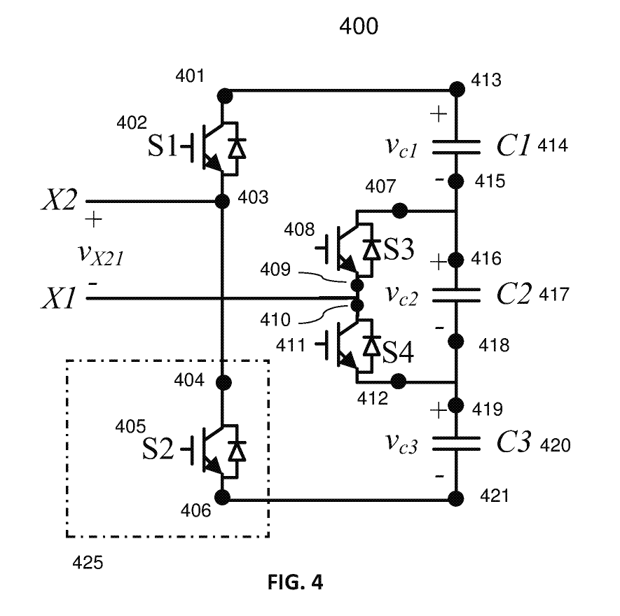

The novel topology converter module can be indicated by its components and its output as a 4 switch/3 capacitor/4 level converter. This topology is again illustrated in FIG. 4 wherein now components and nodes are identified by numerals. FIG. 4 is identical to FIG. 3 but now provided with numerals. The components are first capacitor 414 with first node 413 and second node 415, second capacitor 417 with first node 416 and second node 418 and third capacitor 420 with first node 419 and second node 421. Further components are signal controlled or gated switching devices, each switching device having a signal controlled switch also called a power switch in parallel with a diode. FIG. 4 also includes first switching device 402 with first node 401 and second node 403; second switching device 405 with first node 404 and second node 406; third switching device 408 with first node 407 and second node 409; and fourth switching device 411 with first node 410 and second node 412.

The topology of the 4-level inverter of FIG. 4 in words:
a) a converter with a topology determined by 3 capacitors being a first, a second and a third capacitor, each capacitor having a first and second node;
b) 4 switching devices being a first, a second, a third and a fourth switching device, each switching device having a power switch and parallel connected diode (specifically anti-parallel connected), and each switching device having a first and a second node;
c) the three capacitors being connected in series by connecting the second node of the first capacitor to the first node of the second capacitor and the second node of the second capacitor to the first node of the third capacitor;
d) the first and second switching devices being connected in series by connecting the second node of the first switching device with the first node of the second switching device;
e) the third and fourth switching devices being connected in series by connecting the second node of the third switching device with the first node of the fourth switching device;
f) the first node of the third switching device being connected to the second node of the first capacitor;
g) the second node of the fourth switching device being connected to the first node of the third capacitor;
h) the first node of the first switching device being connected to the first node of the first capacitor;
i) the second node of the second switching device being connected to the second node of the third capacitor; and
j) an inverter output determined by the second node of the first switching device and the second node of the third switching device.
The second switching device 405 is marked by the box 425 to indicate it includes a signal controlled switch or power switch (S2), a diode in parallel and two nodes.

The second switching device 405 is marked by the box 425 to indicate that a switching device includes a power switch (S2 inside box 425), a diode in parallel and two nodes (404 and 406 in this example).

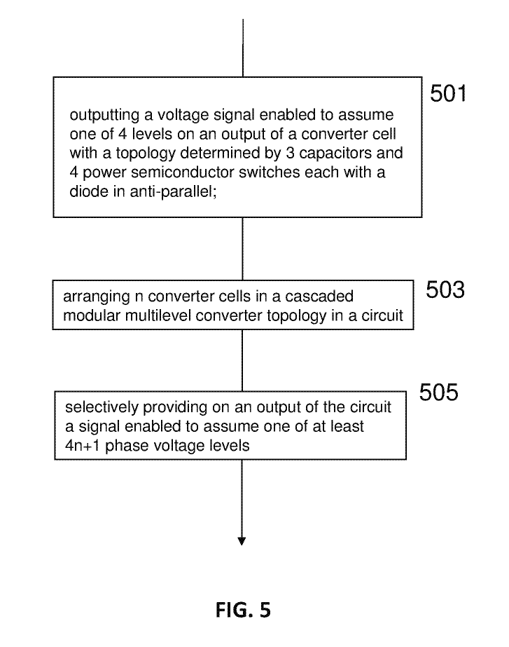

FIG. 5 illustrates a number of steps of a method to generate a multilevel ac signal by using n novel topology converters. In step 501 one of n novel topology 4-level inverters generates a signal enabled to assume one of 4 levels. In step 503 n novel topology converter cells or modules are arranged in a cascaded manner. In step 505 an output generates a signal enabled to assume one of at least 4n+1 phase-to-neutral voltage levels.

One can arrange three sets of n 4-level novel topology converters in cascade to generate 8n+1 phase-to-phase voltage levels.

The following references provide background information generally related to the present invention: [1] O. Lopez, S. Bernet, J. Alvarez, J., D., Gandoy and F. D. Freijedo, “Multilevel multiphase space vector PWM algorithm,” IEEE Trans. Ind., Electron., vol. 55, no. 5, pp. 1933-1942, May 2008; [2] J. Rodriguez, J. Lai, and F. Z. Peng, “Multilevel inverters: a survey of topologies, controls, and applications,” IEEE Trans. Ind., Electron., vol. 49, no. 4, pp. 724-738, Aug. 2002; [3] S. Fazel, S. Bernet, D. Krug, and K. Jalili, “Design and comparison of 4-kV neutral-point-clamped, flying-capacitor, and series-connected H-bridge multilevel converters,” IEEE Trans. Ind., Appl., vol. 43, no. 4, pp. 1032-1040, Jul./Aug. 2007; [4] S. Kouro, M. Malinowski, K. Gopakumar, J. Pou, L. G. Franquelo, B. Wu, J. Rodriguez, M. A. Peroez and J. I. Leon, “Recent advances and industrial applications of multilevel converters,” IEEE Trans. Ind., Electron., vol. 57, no. 8, pp. 2553-2580, Aug. 2010; and [5] A. Lesnicar and R. Marquardt, “An innovative modular multilevel converter topology suitable for a wide power range,” in Proc. IEEE Bologna Power Tech Conf., 2003, pp. 1-3.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the claims.

1. A converter cell to generate a multilevel voltage, comprising:
a first, a second and a third capacitor connected in series;
a first, a second, a third and a fourth power switch, each power switch having a diode connected in anti-parallel, wherein the first power switch is connected in series with the second power switch and the third power switch is connected in series with the fourth power switch;
the first and second power switches connected in series are connected in parallel with the second capacitor; and
a first node of the third power switch is connected to a first node of the first capacitor; and
a second node of the fourth power switch is connected to a second node of the third capacitor.

2. The converter cell of claim 1, further comprising an output formed by a second node of the first power switch and a second node of the third power switch to provide the multilevel voltage.

3. The converter cell of claim 1, wherein the multilevel voltage is a four level voltage.

4. The converter cell of claim 1, wherein the converter cell is part of a circuit containing a plurality of converter cells.

5. The converter cell of claim 4, wherein the circuit contains n converter cells with n being greater than 2 and the circuit is configured to provide a phase-to-neutral output voltage with at least 4n+1 voltage levels.

6. The converter cell of claim 4, wherein the circuit contains 3n converter cells with n being greater than 2 and the circuit is configured to provide a phase-to-phase output voltage with at least 8n+1 voltage levels.

7. The converter cell of claim 1, wherein the converter cell is part of a cascaded modular multilevel converter.

8. The converter cell of claim 1, wherein the converter cell is part of a solar cell power system.

9. The converter cell of claim 8, wherein a capacitor in the converter cell is replaced by a solar cell.

10. A multilevel voltage converter, comprising:
a plurality of 3n converter cells arranged in a cascaded modular multilevel converter topology, each converter cell having a topology determined by 3 capacitors and 4 power semiconductor switches each with a free-wheeling diode, each converter having an output configured to selectively provide one of 4 voltage levels; and
an output enabled to selectively provide one of at least 8n+1 phase-to-phase voltage levels.

11. The multilevel voltage converter of claim 10, wherein the topology is further determined by connecting the three capacitors in series and by connecting two of the four power switches in series.

12. The multilevel voltage converter of claim 11, wherein the two power switches connected in series are connected in parallel to one of the three capacitors connected in series.

13. The multilevel voltage converter of claim 10, wherein the multilevel voltage converter is part of a solar cell power system.

14. A method for generating a multilevel voltage signal, comprising:
outputting a voltage signal enabled to assume one of 4 levels on an output of a converter cell with a topology determined by 3 capacitors and 4 power semiconductor switches each with a free-wheeling diode;
arranging n converter cells in a cascaded modular multilevel converter topology in a circuit; and
selectively providing on an output of the circuit a signal enabled to assume one of at least 4n+1 phase voltage levels.

15. The method of claim 14, further comprising:
arranging 3n converter cells in a cascaded modular multilevel converter topology in a circuit; and
selectively providing on an output of the circuit a signal enabled to assume one of at least 8n+1 line voltage levels.

16. The method of claim 14, wherein the multilevel voltage is generated in a solar cell power system.

17. The method of claim 14, wherein the topology is further determined by connecting the three capacitors in series and by connecting two of the four power switches in series.

18. The method of claim 14, wherein the two power switches connected in series are connected in parallel to one of the three capacitors connected in series.
